(19) United States
(12) Patent Application Publication
(10) Pub. No.: US 2026/0141605 A1
(43) Pub. Date: May 21, 2026

(54) Virtual Assistant with Audio and Video Interactivity

(71) Applicant: Sparkdit Inc., Menlo Park, CA (US)

(72) Inventors: Fadi Victor Micaelian, Menlo Park, CA (US); Elira Elshani, Everett, MA (US); Samvel Asatryan, Yerevan (AM); Angela Guyumjian, Yerevan (AM)

(73) Assignee: Sparkdit Inc., Menlo Park, CA (US)

(21) Appl. No.: 18/951,699

(22) Filed: Nov. 19, 2024

(51) Int. Cl. G06T 13/40; G06T 13/20; G10L 13/00; G10L 15/18

(52) U.S. Cl. CPC G06T 13/40; G06T 13/205; G10L 13/00; G10L 15/1822

(57) ABSTRACT

A digital agent interacts with a user and provides audio and visual outputs and accepts audio inputs and processes audio inputs substantially in real-time to generate an inferred intent. A context is determined, and a contextual trade-off analysis of the audio input is performed to generate the inferred intent of the audio input. One or more outputs are provided to the user in the form of questions as a function of the inferred intent. Further inputs are received to determine one or more modified contexts and one or more inferred intents. Outputs to the user take the form of animations of at least a portion of a human being speaking audio output, the audio output is synchronized with a visual representation of the human being and provides a substantially live interaction with the user.

### AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

This disclosure relates generally to computerized information systems and more particularly to computerized assistants.

### BACKGROUND

The advent of artificial intelligence (AI) has significantly transformed the way humans interact with digital systems. From chatbots to voice-activated assistants, modern technologies have increasingly focused on enabling more natural and human-like interactions between machines and users. However, despite advancements in natural language processing (NLP) and AI-driven conversational agents, there remains a gap between how users interact with current systems and the experience of engaging in conversation with a human.

Existing virtual assistants, such as those employed by major technology platforms, typically rely on predefined responses and rigid command structures that limit the flexibility and personalization of user interactions. Users often experience frustration when their queries are misunderstood or when responses are overly mechanical and impersonal. Furthermore, these systems tend to be language-specific, with limited support for engaging in meaningful conversations across different languages. Emotions, attitude and tone, essential aspects of human communication, are also often neglected in current virtual agent solutions. As such, there is a need for virtual agents that provide a more human-like experience, allowing users to interact in a way that feels more intuitive and conversational, and that includes language and context.

### SUMMARY

To address these limitations, the disclosed methods and systems describe a virtual agent designed to closely mimic human-to-human interactions, creating a more seamless, intuitive user experience across a variety of services. The disclosed virtual agent has the ability to interact with users through voice, processing and understanding user input in real-time, and responding in a way that captures not only the meaning but also the nuance of the conversation. The virtual agent processes audio input from the user, extracting the intention behind the speech through advanced AI models and continues the interaction based on the inferred intent. This allows for a natural and dynamic conversation flow, similar to that of a human interaction.

In one embodiment, a computer implemented method provides a digital agent that interacts with a user. The digital agent provides audio and visual outputs and accepts audio inputs. The method includes accepting audio input from a user and processing the audio input substantially in real-time to generate an inferred intent of the audio input. A context of the audio input is determined from a provided category. A contextual trade-off analysis of the audio input is performed with the context to generate the inferred intent of the audio input. One or more outputs are generated and provided to the user in the form of questions as a function of the inferred intent. Further inputs are received from the user to determine one or more modified contexts and one or more inferred intents. The outputs to the user take the form of animations of at least a portion of a human being speaking audio output and the audio output is synchronized with a visual representation of the human being to provide a substantially live interaction with the user. This provides a live visual representation of a person or an avatar.

Unlike existing systems, in certain embodiments, the disclosed virtual agent is multi-lingual and can engage users in different languages, thereby expanding its applicability across global markets. Moreover, the agent can adapt its tone, personality, and attitude to suit the context of the conversation. Whether the situation demands a professional and formal tone, or a more relaxed and humorous interaction, the agent can tailor its responses, accordingly, enhancing user satisfaction and engagement.

The ability of the virtual agent to support different attitudes introduces a novel aspect to AI-driven communications. By simulating emotional and contextual responses, the agent can forge deeper connections with users, making interactions more personalized and meaningful. This has applications across numerous industries, including customer service, education, healthcare, and entertainment, where the quality of human-like interaction is increasingly valued.

As consumer demand for personalized and human-like digital experiences continues to grow, the disclosed embodiments meets a critical need for a versatile, adaptive, and intuitive virtual agent capable of communicating naturally, in real-time, in multiple languages and emotional contexts and with natural gestures. As will be appreciated by those skilled in the art, the present disclosure describes embodiments that improve the operation of computing systems by providing more natural and interactive interfaces of such computing systems to permit natural conversational interaction with computing systems.

Certain embodiments of the disclosed virtual agent are able to adapt their attitude and tone to suit the context of the conversation, thereby providing a more personalized and human-like experience. Whether the user requires a formal, professional interaction or a more relaxed, friendly tone, the agent can adjust accordingly. The virtual agent incorporates several modules, including a speech recognition module, intent extraction module, language translation module, and flow control module, all working in tandem to create an intuitive and adaptive conversational agent.

The system can be applied in various sectors, such as customer service, healthcare, education, and e-commerce, where users interact with automated systems and expect more natural, conversational experiences. Additionally, the system includes a robust flow control mechanism, ensuring smooth and logical task progression, while an admin and log module provides secure monitoring and access management.

The disclosed virtual agent is designed to bridge the gap between users and automated systems, enabling more meaningful and effective interactions by simulating natural human communication in both language and attitude. Here the term “attitude” as used herein with respect to the disclosed virtual agent refers to a mental position with regard to a fact or state (e.g., a helpful attitude) or a feeling or emotion toward a fact or state (e.g., a negative attitude or an optimistic attitude). In this regard, the term “attitude” does not necessarily connote a negative or hostile state of mind or cocky or defiant or arrogant manner and it does not refer to any physical positioning.

Additional aspects related to the invention will be set forth in part in the description that follows, and in part will be apparent to those skilled in the art from the description or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive techniques.

FIG. 1 is high level block diagram of an embodiment of a computerized system that implements the disclosed virtual agent.

FIG. 2A is a block diagram illustrating operation of IEM 106 FIG. 1.

FIG. 2B is a flow diagram illustrating operation of IEM 106 of FIG. 1.

FIG. 3 is a block diagram showing further details of IEM 106 of FIG. 1.

FIG. 4 is a block diagram showing further details of trade-off scoring 302 of FIG. 3.

FIG. 5 is a flow diagram illustrating showing operations performed to implement the disclosed virtual agent.

FIG. 6, FIG. 7 and FIG. 8 illustrate example visual representations of the disclosed virtual agent.

FIG. 9 is a block diagram of computer hardware that may be employed in certain embodiments of computer systems described herein.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of the present invention. The following detailed description is, therefore, not to be construed in a limited sense.

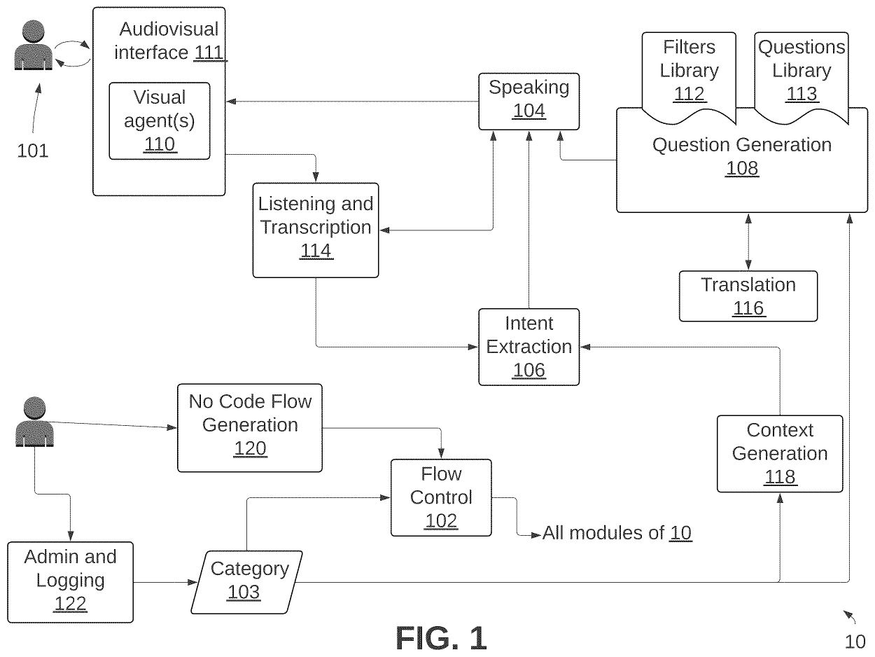

FIG. 1 is high level block diagram of an embodiment of a computerized system 10 that implements the disclosed virtual agent which interacts with a user 101. Shown in FIG. 1 are several interconnected modules that combined implement an embodiment of the disclosed virtual agent. Each module performs specific tasks that contribute to creating a seamless, human-like conversation flow for a particular application. Flow Control Module (FCM) 102 takes as input a category 103, which can be service category, industry category such as healthcare, retail, finance, or education. A category is a classification of the type of recommendation sought. For example, it can be a car (product), a medical treatment (selection of a treatment for knee arthritis), a service, such as which plumber do I select, or what software consulting house to pick between Accenture PwC and KPMG.

FCM 102 manages the flow of tasks within the modules shown for system 10, ensuring the user interaction follows a logical sequence. If there is inactivity for a predefined number of seconds (N seconds), the FCM 102 triggers a termination response, gracefully ending the conversation with the user 101 or can direct the user 101 to a different type of interaction or interface. FCM 102 acts as the conductor or coordinator of the system 10, controlling when certain actions are taken. For example, if user 101 fails to respond, the system 10 can proactively manage the session by ending it or asking follow-up questions. Speaking Module (SM) 104 converts text-based outputs into verbal communication that is delivered to the user 101. This can be implemented with a visual representation of an avatar or a pseudo real dynamic image that is capable of speaking text with expression and emotions. SM 104 enhances accessibility by enabling the system 10 to “speak” to the user in a natural conversational fashion, similar to how a human would in a conversation. SM 104 takes as input text that is provided by either the Intent Extraction Module (IEM) 106 or Question Generation Module 108. SM 104 generates audio output that permits a visual agent 110 of audiovisual interface 111 to read audio output aloud to the user 101 and to provide a live visual representation of a person or avatar speaking the audio output, allowing for more natural audio-based interactions.

Question Generation Module 108 includes a Fillers Library 112 and a Questions Library 113. FCM 102 coordinates operation of SM 104 in conjunction with the Listening and Transcription Module (LTM) 114 to maintain a continuous conversation loop. Examples of how FCM 102 may interact with user 101 include as greetings: (i) “Hi, Fadi, how are you?”, (ii) “How's it going?” or (iii) “Your highness, how's the weather today and how are you feeling?” As can be seen from the foregoing, the system 10 permits the LTM 114 to interact with the user 101 in a variety of speaking styles from casual to formal. FCM 102 enables definition of the flow of a conversation with user 101. For example, first a greeting then asking user 101 what they are shopping for (in a shopping application), then progressing deeper into the conversation.

LTM 114 takes as input encoded audio data representing user 101's spoken input and transcribes it into text. In one embodiment, LTM 114 employs a Large Language Model (LLM) (not shown). The LLM may take the form of a conventional LLM service such as ChatGPT™ as provided by OpenAI. org. LTM 114 interacts with an LLM via an application programming interface provided by the LLM. Output of LTM 114, which is transcribed text, is provided to IEM 106. In addition to text input from LTM 114, IEM 106 receives as input a context component. The context component ranges from a loose indication of the subject at hand but can be more detailed to describe the possible outcomes of the module. In one instantiation a loose indication of the possible outcome may be as simple as capturing a set of keywords that may describe the state of a criterion. On the other extreme the context may be very specific such as a preference between color or brand for a consumer where the output is expected to be a set of pair of all the available colors with their preference rating by a user. So, in such an example, the context is a score that reflects the affinity for a specific user for red, blue or white shorts. And the anticipated outcome may for example, be a score associated with each possible color-blue:80, red:18, white:). In the foregoing two examples, with the loose requirement, the intent may be extracted by extracting keywords. In the specific requirement, there may be five criteria each with an associated weight. The system 10 will ask the user 101 various questions to obtain the needed answer. For example, if the system 10 asks the user 101 for a preferred price and gets as an input “between 300-400 dollars” the system 10 can ask for more specific answer. In an application for searching for a house, if the user 101 provides a vague input the system 10 may capture certain keywords from the user's response and ask a more specific question. This process enables the system to understand user answers, commands or queries in a natural language format, making the interaction more intuitive.

The Question Generation Module 108 dynamically generates relevant questions based on the category of the interaction, such as trade-off questions, criteria behavior questions, or repeated questions when needed. It takes category 103 data as input, determining the type of question that best fits the current context. This module ensures that the conversation stays engaging and personalized by pulling questions from a predefined Fillers Library 112 and Questions Library 113, depending on the task or user interaction. The system tailors these questions to the specific needs of the conversation. Additionally, the Question Generation Module 108 interacts with the Translation Module 116 to ensure that the questions are translated into the appropriate language when necessary, and that they align with the user's preferences for tone and attitude. This approach enables the virtual agent to maintain a natural and adaptive dialogue, suited to the context of the conversation.

The Translation Module 116 incorporates emotions, attitude (tone), language and locale into its translation of a question generated by Question Generation Module 108. Examples of attitude include a compassionate attitude, a familiar attitude, or a business, i.e. more formal, attitude. Examples of emotion include happy or somber. Examples of language include English, French, Spanish, Mandarin, etc. Examples of locale include United States, England, China, Australia. Though United States and England may use the same language the locale enables localization for tone, language and units of measure (Fahrenheit vs. Celsius, miles vs. kilometers, etc.) Any given application for which system 10 is configured will be configured with one or more attitude(s), emotion(s), language(s) and locale(s). The output of Translation Module 116 is text that has been translated from the question generated by Question Generation Module 108 to reflect the desired the attitude, emotion, language and locale.

Questions library 113 is a generic library; e.g. if data type is number then ask for an answer that is a number; Fillers library 112 contains statements or interjections or jokes or others that make the conversation more human; in contrast the questions are very specific to extract some specific response needed to provide a better recommendation or decision

The Question Generation Module 108 dynamically generates relevant questions based on the category of the interaction, such as trade-off questions, criteria behavior questions, or repeated questions when needed. It takes category data as input, determining the type of question that best fits the current context. The Question Generation Module 108 ensures that the conversation stays engaging and personalized by pulling questions from predefined Fillers Library 112 and Questions Library 113, depending on the task or user interaction. The system 10 tailors these questions to the specific needs of the conversation.

The Context Generation Module 118 takes a category 103 as input and outputs relevant types of data, acceptable ranges of values, and other pertinent information for that specific category. For example, if the category 103 is cars, and criteria is brands, then accepted types may be Honda, Ford, Hyundai, Peugeot etc. If criteria is performance, then accepted types may be horsepower measured in the US as a number from zero to one-thousand horsepower. By way of another example, in a laptop-buying scenario, the output might include information about the available list of CPUs for laptops or the minimum and maximum price range for products in that category. The Context Generation Module 118 not only provides necessary context for the interaction but also plays a crucial role in supporting the IEM 106. By supplying the context around the user's input, it allows the IEM 106 to better understand the meaning behind the user's responses. This context helps the system interpret ambiguous or incomplete answers by relating them to the category-specific information (such as available options or price ranges). Additionally, the Context Generation Module 118 assists in building the structured data output from the user's input. For instance, if a user is interacting with the agent to buy a laptop and mentions specific criteria like color or price, the Context Generation Module 118 provides the relevant details (such as valid color options and price ranges) to the IEM 106, enabling it to create accurate, structured data.

The No Code Flow Generation Module 120 allows non-technical users or administrators to configure workflows for the virtual agent without the need for coding. By taking flow generation instructions as input, this module provides output in the form of pre-configured workflows that guide the behavior of the system. In one embodiment, the No Code Flow Generation Module 120 provides a palette of actions that can be performed. A developer of an application to be executed by system 10 may by way of a visual interface, drag and drop various actions and provide required inputs and outputs. The module 120 generates the required code, such as, for example, using pre-generated code and filling in the necessary variables. question generation and input capture are pretty unique along with listening to the user and speaking to the user. The palette includes generation of the question, translate, read the question listen to the answer and extract the intent.

In one embodiment, the module 120 permits a designer to select various elements by dragging and dropping them on a canvas then linking them with arrows and decision elements. Creating a sequence of either activity or logical elements serves the purpose of enabling an average user to create their own flows without having any programing knowledge. Its flexibility ensures that a wide range of interaction types can be handled, allowing users to design specific flows based on their unique requirements. The No Code Flow Generation Module 120 connects directly with the Flow Control Module 102, ensuring that tasks and workflows are executed smoothly within the virtual agent. In an implementation of this module a user may be presented with a palette of elements and by dragging and dropping these elements and connecting them on a canvas of white board, the user would create a flow that reflects the flow of the conversation and the process of developing a query that yields superior answers.

No Code Flow Generation Module 120 in one embodiment provides a visual or audio interface that permits input by way of speaking module 104 which causes generation of a script by IEM 106. Additionally, or in lieu of, module 120 may permit a list of questions to be entered along with rules for the questions and module 120 generates the code to cause operation of the various modules of system 10.

The Admin and Log Module 122 is responsible for logging all system activities, managing access, and controlling credentials. This module collects interaction data, ensuring that every action taken by the system is recorded. It plays a vital role in ensuring security and accountability, especially in enterprise environments. By managing credentials and access controls, this module ensures that only authorized individuals can interact with certain parts of the system. The Admin and Log Module 122 interacts with all other modules, providing comprehensive tracking and management of the system's operations.

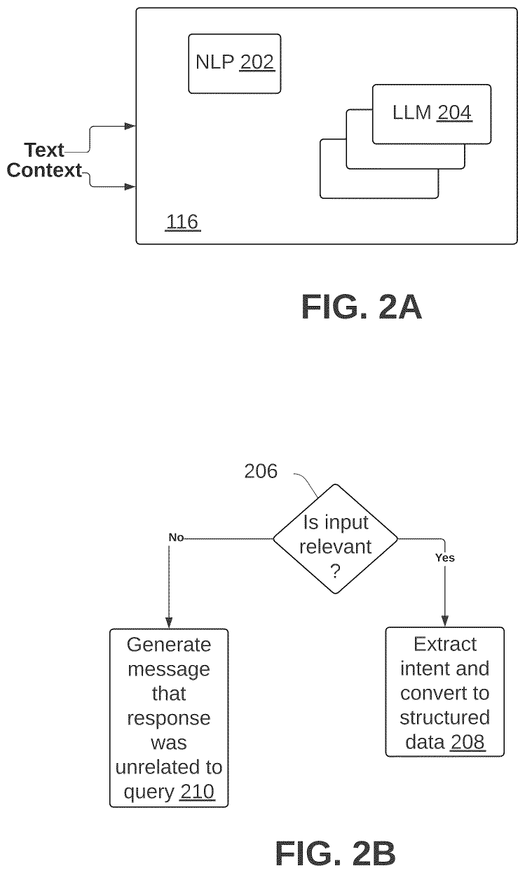

FIG. 2A and FIG. 2B show respectively a block diagram and flow diagram illustrating operation of IEM 106. The transcribed text generated by LTM 114 is provided to IEM 106 which uses natural language processing (NLP) 202 to determine the user 101's intent behind the provided input. In one embodiment, the NLP 202 is performed by one or more of the LTMs 114 in response to prompts generated by IEM 106. IEM 106 analyzes both the literal text and the surrounding context, to ensure an accurate understanding of the user's answer. IEM 106 keeps track of the questions the system 10 has asked the user 101. When a response is received, IEM 106 cross-references the response with the most recent question to determine if the user's answer directly relates to the most recent question. The output of IEM 106 is either (i) an out-of-context message, which indicates that user 101's input was mis-understood or was not related to the question, or (ii) the extracted intent in the form of structured text. IEM 106 plays a central role in the virtual agent's functionality, as it converts user 101 input into actionable data. With respect to the operation of IEM 106, the term “intent” means determining the goal or purpose of the user's answer.

IEM 106 performs dynamic intent extraction enhanced by contextual trade-off analysis, enabling seamless application across multiple domains such as e-commerce, education, and conversational AI. This novel feature moves beyond standard natural language processing by leveraging fine-tuned large language models (LLMs) 204, which provide enhanced understanding and multi-purpose adaptability. These LLM models 204 enable the system 10 to handle nuanced user input, adapt responses to specific domains, and process trade-offs in user preferences to deliver highly personalized interactions. The fine-tuning involves querying the LLM 204 in a specific way, more specifically by providing prompts that cause the LLM 204 to provide an answer in the context in which the conversation with the user 101 is occurring. In one embodiment the LLMs 204 are commercially available LLMs.

IEM 106 employs both LLM input along with expert knowledge. This form of guided LLM with context yields superior result when the guidance provides specifics related to the desired outcome. The expert knowledge enables the system 10 to leverage the knowledge built and accumulated over the years. The latter can be captured in the form of rules, expert system, computational logic or other similar programs that serves the purpose of teaching the machine to apply the principles and reasoning that a human would. The combination of LLM and generative AI in particular along with expert knowledge yields superior results.

Once user input is captured, and transcribed by LTM 114, the output of 114 is provided to IEM 106, which employs advanced NLP algorithms provided by fine-tuned LLMs to accurately identify the user's intent. Fine-tuning these LLMs allows the system 10 to specialize in industry-specific contexts by training on curated datasets tailored to reflect the nuances of each use case. In one embodiment, IEM 106 employs context generated by module 118 to generate one or more prompts to one or more commercially available LLMs to generate context specific responses. This improves the system 10's ability to interpret jargon, adapt to varied conversational styles, and ensure accurate intent extraction even when inputs are ambiguous or complex. IEM 106 analyzes both the literal content of the transcribed text and the context of the conversation to ensure accurate understanding. If the input upon testing 206 is relevant, IEM 106 at 208 extracts the intent and converts it into structured data; if the input is irrelevant or out of context, IEM 106 at 210 generates a message indicating the response was unrelated to the query. This structured data drives logical system responses and guides subsequent interactions. For example, system 10 may ask user 101 a question that seeks selection of one of eight criteria, with each criterion being scored between zero and 99. Another example would be where the input is a speech or lecture and the output is a listing of the keywords. Another example is shoe selection where a user is asked a preference and weighting for each preference between four colors (e.g., beige, brown, burgundy, black). The output in this example would be a listing of shoes following by a score for each shoe.

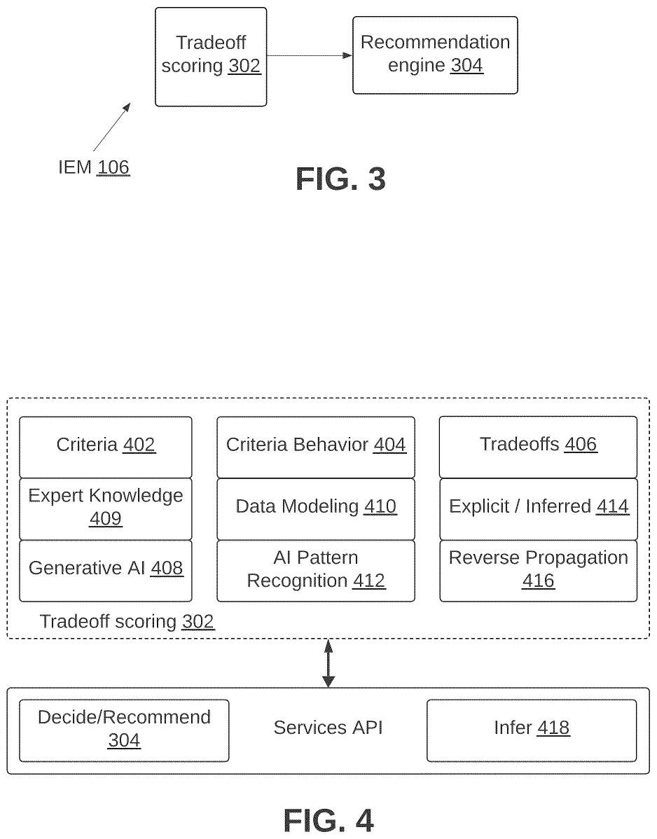

The system 10 advantageously processes trade-off preferences in e-commerce interactions. For instance, if a user expresses, “I like red more than purple, but I don't want pink,” IEM 106, shown in further detail in FIG. 3, not only extracts the literal intent but also evaluates the nuances and hierarchy of these preferences. IEM 106 converts the sentence into scores for each color, for example, as follows: red=90, purple=50, pink=zero. Another example: “I love red but will take purple at half the price and don't want pink. This may be converted by IEM 106 into: red=100, purple=50, and pink=zero.

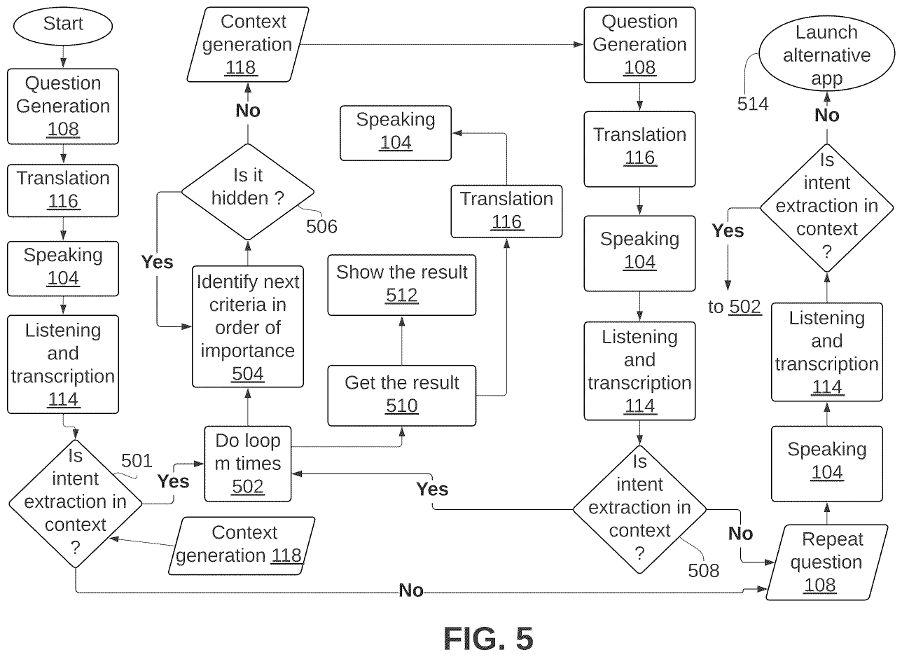

Using trade-off scoring mechanisms 302, IEM 106 assigns weights to each preference and feeds this data into the recommendation engine shown in FIG. 4. This ensures that product suggestions align with the user's priorities while filtering out less relevant options, resulting in a more personalized shopping experience.

In a decision intelligence implementation, the system 10 by way of trade-off scoring mechanisms 302 captures the nuance of a decision or a recommendation or a search. This is performed by the modules of 302 shown in further detail in FIG. 4, which include: (i) a set of criteria 402 that impact the decision, which can be as extensive as required by the application (ii) the criteria behavior or the logic 404 that is applied to a criterion. The criteria behavior 404 may be dictated by rules or influenced by the individual or group making the decision in the case of a collaborative or shared decision. Some criteria behavior 404 are universal by nature. For example, for two items that are exactly identical with the exception of their price, a buyer will always favor the lowest price. The criteria behavior 404 may reflect individual preferences. For example, Steve may prefer blue over red while Cynthia is ambivalent between blue or red and Alison may have a very strong preference for red and does not want blue. These three behaviors, with respect to color, are personalized. They reflect how an individual perceives and appreciates a criterion given the available possibilities.

The criteria 402 for a category 103 are generated by a generative AI module 408 or by an expert knowledge module 409. Generative AI module 408 forms a query in a form required by an application programming interface of a generative AI engine (not shown) and receives from the AI engine a set of criteria. Expert knowledge module 409 retrieves a list of criteria from a database that may be provided by one or more experts. Criteria behavior data structure 404 associates to each criterion 402 a logical and/or mathematical operator. Data modeling module 410 provides an extensible library of utility curves to AI Pattern Recognition module 412 which is trained to identify a utility curve provided by Data Modeling module 410 that fits criteria 402. Tradeoffs 406, or the relative weight (importance) associated to each criterion, are generated by module 414 which accepts tradeoffs explicitly expressed by users or measures the tradeoffs by an inference engine that reverse engineers a decision via reverse propagation engine 416 by inferring tradeoffs based on a given subset ranking. Services provided by tradeoff scoring module 302 are accessible by a set of Application Programming Interfaces (APIs) that include APIs 304 for generation of a decision or recommendation and APIs 418 for generation of an inference.

One way to capture the criteria behavior 404 is to use a parametrizable utility function. For color it would be a step function that is set by the user 101. For price it may be a linear function within a certain range followed by a quadratic function at a given price point that the user 101 sets and that reflects their personal assessed price for the item.

The elements shown in in FIG. 4 also include (iii) a set of tradeoffs 406 that express typically the needs and balance the various criteria 402. The tradeoffs 406 reflect the relative importance of the criteria 402. Tradeoffs are the key to tying the entire solution together and delivering superior results. Module 302 extracts the nuances of each of these elements as needed by the application to yield the best decision, while having an optimized user experience. In one embodiment, the trade-off scoring mechanisms 302 may take a form as described in U.S. Pat. No. 6,714,929, entitled Weighted Preference Data Search System and Method, which was filed on Apr. 13, 2001, and issued on Mar. 30, 2004, which is hereby incorporated by reference in its entirety. This patent describes usage of utility functions that are employed by a tradeoff engine to score and rank result.

Tradeoff scoring module 302 in one embodiment includes a weighted preference generator and a weighted preference data search engine. The weighted preference generator develops weighted preference information including weights corresponding to search criteria. The weighted preference data search engine uses the weight of the preference data to search an information source and to provide an ordered result list based upon the weighted preference information.

The weighted preference data search system is used to search a number of data sources including flat databases, text-based databases, and data streams. In the case of data streams, the search system can search in real time. For example, in an application for selecting shoes, the data source may be a database containing an inventory of available shoes.

The weighted preference generator can accept inputs from user 101 such as for example, selection of search criteria, the adjustment of weights with respect to the search criteria, and an indication of subjective ordering of at least one of the search criteria. Alternatively, or additionally, the weighted preference generator can provide weighted preference information based upon at least one of default values, automated heuristics, or other sources of input such as from devices such as machine sensors, temperature gauges, etc.

The weighted preference data searching includes determining weighted preference information including a plurality of search criteria and a corresponding plurality of weights signifying the relative importance of the search criteria, and querying an information source and ranking the results based upon the weighted preference information.

A subjective ordering may also be provided for at least one search criteria. As an example, the color of a car might be very important to a user and therefore given a relatively high numerical weight. However, there is a subjective aspect to color. For example, for one user the color red for a car might be very important, while for another user having a black car is very important. Subjective ordering permits criteria such as “color” to be associated with a subjective ordering of which colors are desired by the user and in what order.

In one embodiment, determining weighted preference data includes determining whether or not there should be further input from user 101. Without further user input, at least one of default and automatically heuristically determined weights are provided to the search engine. If further user input is taken, it is determined whether the user 101 should be allowed to select criteria. If not, at least one of default and automatically heuristically determined criteria selections is made for the user 101. If the user 101 is allowed to select criteria, user selection is input into the system 10. Additionally, it may be determined whether the user 101 should be able to adjust weights. If not, at least one of default and automatically heuristically determined weights is provided by the system 10. If the user 101 is allowed to select weights, the weights are input into the system 10 by the user 101. The user 101 may also be requested to input subjective ordering into the system 10. If the user 101 cannot specify subjective ordering, the system 10 may provide any needed ordering.

The weighted preference data searching may also include reading information from a data source including a set of alternatives, where each alternative contains values for a number of criteria. Next, the distance to an ideal value is measured and then normalized and stored. Then, for each criterion, the normalized distance data is multiplied by its corresponding weight and accumulated to obtain a score for the alternative. The alternatives are then ranked by their scores.

An alternative method for weighted preference source searching includes reading information from a data source including data for a plurality of alternatives. Next, for each criterion of each alternative the distance to an ideal value is measured and normalized distance data is created and then multiplied by its corresponding weight and accumulated to obtain a score for the alternative. The alternatives are then ranked based upon their scores.

In one embodiment, the IEM 106 is highly adaptable, with applications extending beyond e-commerce into education, customer service, and more. For example, in an educational setting, the flow begins with the LTM 114, which captures and transcribes lecture content. The transcribed text is processed by the IEM 106, which utilizes generative AI to create various outputs that enhance the learning experience. Examples of such outputs include: (i) Cliff note summaries Concise overviews of the lecture, highlighting key concepts and takeaways; (ii) Podcasts-Audio content based on the lecture, making the material easy to review on demand; (iii) Extensive transcriptions-Word-for-word lecture transcriptions for in-depth study; (iv) Keyword identification-Extraction of key terms and concepts to aid in indexing and quick reference; (v) Supplementary learning material-For new concepts introduced, the system 10 provides links to relevant online resources, supporting students and attendees in becoming more proficient in the subject.

This versatility highlights the adaptability of the IEM 106 across diverse domains. Whether facilitating a personalized shopping experience or enriching educational content, IEM 106 plays a central role in converting unstructured input into actionable insights. Through its integration with fine-tuned LLMs and trade-off analysis mechanisms, the virtual agent engages meaningfully with users, delivering tailored responses that improve both user satisfaction and operational efficiency.

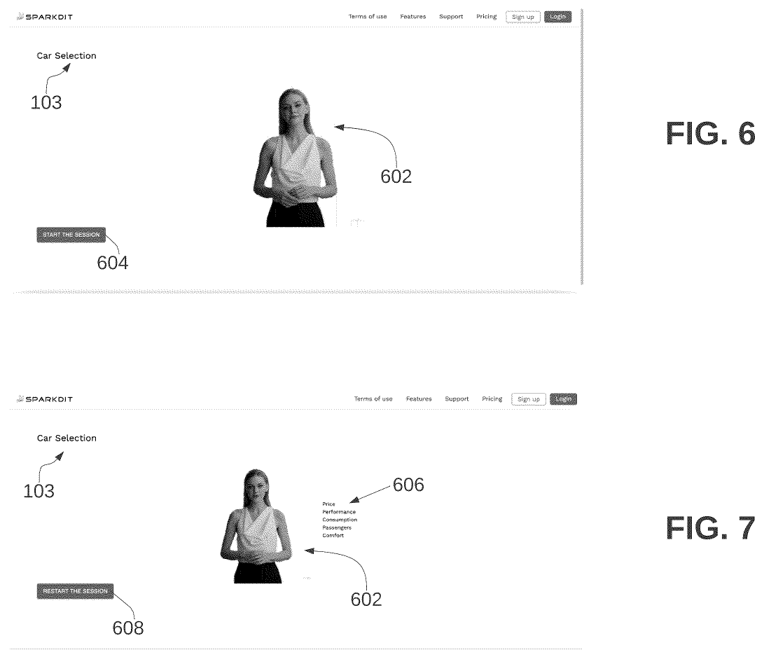

Overall operation of the system is shown in the flowchart of FIG. 5. The process begins with a Start Module 200, where the system takes an input representing a category 103. This category defines the context of the interaction, such as a product the user is interested in (e.g., laptops) or a specific service the user requires. The category sets the foundation for the subsequent flow of interactions by establishing the framework of the conversation, which will guide the virtual agent's behavior. Operation of the start module 200 is coordinated by the Flow Control Module 102.

Once the category is established, the flow moves to the Question Generation Module 108, where the first question is provided to the user 101. This question is based on the context provided by the category 103. For example, if the category 103 is laptop purchasing, the question could ask the user about the importance of specific criteria such as price, performance, color, or weight. This module doesn't deliver the question to the user; it merely the generates the question based on predefined criteria for that category 103.

The system transitions to the Translation Module 116 which identifies the user's preferred language and the emotional tone or attitude that the virtual agent should adopt. The language is typically identified based on the user's browser settings, ensuring the conversation is conducted in the user's preferred language. Meanwhile, the agent's attitude or emotion, such as whether it should communicate formally or informally, is derived from the application's settings or configurations. For example, in an application for a customer support scenario, the virtual agent may be configured to sound empathetic and polite. The term “emotion” as used with respect to Translation Module 116 means a natural instinctive state of mind deriving from one's circumstances, mood, or relationships with others, or an instinctive or intuitive feeling as distinguished from reasoning or knowledge.

The system then moves to Speaking Module 104, where the virtual agent verbally presents the question to the user 101. Module 104 converts the text of the generated question into speech, allowing the virtual agent to “speak” the question in a natural, conversational manner.

After the question is spoken, the LTM 114 becomes active to listen for the user's response, capture their audio input, and transcribe it into text. The transcribed text becomes the foundation for further processing, as it now represents the user's input in a format the system can analyze.

With the transcribed text ready, the system proceeds to the Context Generation Module 118, which supports the IEM 106. The Context Generation Module 118 provides background information and a range of acceptable values or criteria relevant to the category 103. This can include valid options for color, price ranges, or other specifications the user may mention. The IEM 106 then analyzes at 501 the transcribed text in relation to the context provided. It checks if the user's response is relevant to the question and falls within the expected range of values. For example, if the user mentioned “price” or “performance” when asked about laptop criteria, the system validates that these are appropriate responses.

If the user's response is determined at 501 to be in context, the system 10 enters a loop where it asks m additional questions 502. This loop 502 continues for as many questions as necessary, up to the defined m limit. If the response is out of context, the system 10 repeats the question. If, after repeating, the system 10 still cannot extract valid intent, the virtual agent may trigger at 514 an alternative application which may be better suited to the user's needs.

Within the m-loop 502, the system operates by identifying the next most important criteria (504) to ask about, based on the context and category. For instance, if the user indicates that “color” and “price” are more important than “weight” or “size” in a laptop purchase, the next questions will focus on those prioritized criteria. Before asking a question, the system 10 checks at 506 whether the criteria are hidden. If the criteria are hidden, the system 10 skips the question. Otherwise, it adds the question to the list of those to be asked within the m questions. An example of hidden criterion may be the inventory, for instance. Inventory level determines the importance of the criterion, not the user. So, it would make no sense asking the user about it. Hence the need to have some hidden criteria.

After verifying whether the criteria are relevant and not hidden, the system 10 proceeds to gather additional context via Context Generation Module 118 related to such criteria. For example, if “price” is the next important factor, the system retrieves the appropriate price range or other relevant information. The Question Generation Module 108 then formulates a question around this criterion, and the Translation Module 116 ensures that the question is appropriately translated into the user's language if necessary.

Once the question is generated, the system 10 cycles through the Speaking Module 104 and LTM 114 once again to deliver the question and capture the user's response. If the system 10 does not understand the response or if it's out of context 508, the virtual agent repeats the question, ensuring the user has another opportunity to clarify their input.

At the end of the m-loop 502, the system 10 obtains and compiles the results (510) based on the user's answers to each of the criteria-focused questions. These results can include structured data like the user's preferred color, acceptable price range, and any other criteria deemed important. Once the loop 502 finishes, the application can either display 512 the results to the user 101 or have the virtual agent read them aloud, depending on the context of the interaction and the user's preferences.

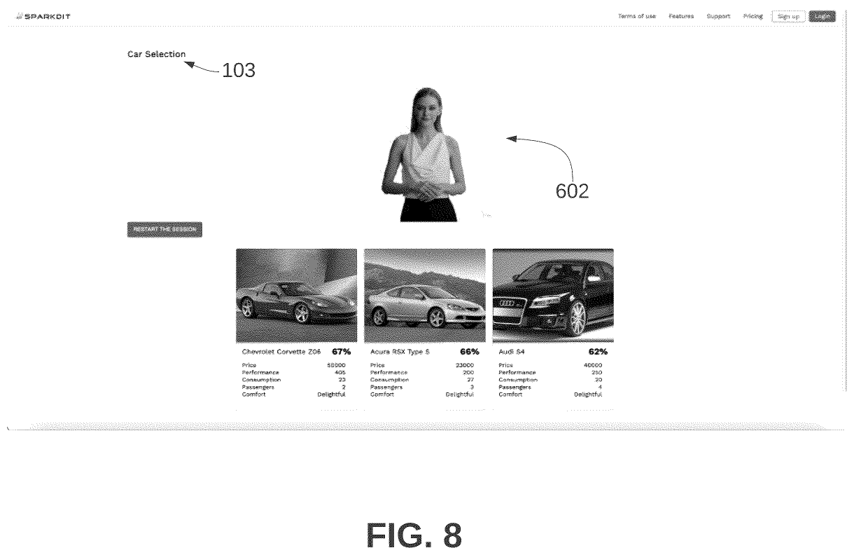

FIGS. 6, 7 and 8 illustrate an example of operation of the system 10 by way of sample screen shots of a visual agent 110. In FIG. 6, the category 103 for the interaction is Car Selection. This is determined by the application which is configured as a car selection application. The virtual agent 602, displayed at the center of the screen, engages with the user 101 to assist in selecting a car. In an implementation, the session is initiated by clicking a “START THE SESSION” button 604, triggering the virtual agent 602 to ask the user an initial question and initiate the dialog. Typically, these questions are relevant to the selected category 103. Another instantiation does not require the presence of the start session button 604 but initiates the conversation upon launching the application.

In FIG. 7, the virtual agent 602 presents a set of criteria 606 for the Car Selection category 103. These criteria 606—price, performance, consumption, passengers, and comfort—are already part of the predefined car selection process. The virtual agent 602 reads this list to the user 101, asking which of these criteria is most important to them, guiding the user through a more personalized car selection experience, a process which corresponds to the loop 502 of FIG. 5 and other associated operations of FIG. 5. The interface also features a “RESTART THE SESSION” button 608, allowing the user to reset and begin the process again.

In FIG. 8, the results of the car selection, corresponding to 512, process are displayed. The virtual agent 602 presents three car options based on the user 101's selected criteria. Each car is shown with its corresponding rating and details, including price, performance, consumption, passenger capacity, and comfort level. This screen allows users to compare the options based on how closely each car aligns with their preferences, aiding them in making an informed decision. Additionally, the “RESTART THE SESSION” button remains available for the user to reset the process and refine their selection if needed. As seen in FIGS. 6, 7 and 8, the virtual agent 602 takes the form of a human being providing outputs to the user 101 by speaking to the user 101 in a conversational tone with the visual representation of the virtual agent being synchronized with the audio output to visually represent the visual agent speaking to the user 101.

The embodiments herein can be implemented in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may also include a device or product having content stored thereon at time of sale or delivery. Thus, delivering a device with stored content, or offering content for download over a communication medium may be understood as providing an article of manufacture with such content described herein.

The terms “computer system” and “computing device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

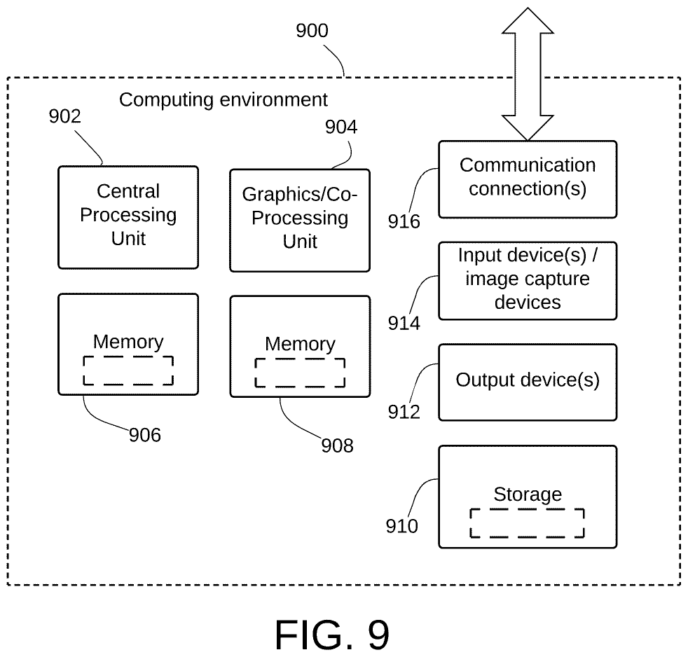

FIG. 9 illustrates a block diagram of hardware that may be employed in an implementation of the platform 10 as disclosed herein, in which the described innovations may be implemented in order to improve the processing speed and efficiency with which the hardware operates to perform the functions disclosed herein. With reference to FIG. 9 the computing system 10 includes one or more processing units 902, 904 and memory 906, 908. The processing units 902, 904 execute computer-executable instructions. A processing unit can be a general-purpose central processing unit (CPU), processor in an application-specific integrated circuit (ASIC) or any other type of processor. The tangible memory 906, 908 may be volatile memory (e.g., registers, cache, RAM), non-volatile memory (e.g., ROM, EEPROM, flash memory, etc.), or some combination of the two, accessible by the processing unit(s). The hardware components in FIG. 9 may be standard hardware components, or alternatively, some embodiments may employ specialized hardware components to further increase the operating efficiency and speed with which the computer system 10 operates. The various components of computer system 10 may be rearranged in various embodiments, and some embodiments may not require nor include all of the above components, while other embodiments may include additional components, such as specialized processors and additional memory.

Computing system 10 may have additional features such as for example, storage 910, one or more input devices 914, one or more output devices 912, and one or more communication connections 916. An interconnection mechanism (not shown) such as a bus, controller, or network interconnects the components of the computing system 10. Typically, operating system software (not shown) provides an operating system for other software executing in the computing system 10, and coordinates activities of the components of the computing system 10.

The tangible storage 910 may be removable or non-removable, and includes flash memory, magnetic disks, magnetic tapes or cassettes, CD-ROMs, DVDs, nonvolatile random-access memory, or any other medium that can be used to store information in a non-transitory way and that can be accessed within the computing system 10. The storage 910 stores instructions for the software implementing one or more innovations described herein.

The input device(s) 914 may be a touch input device such as a keyboard, mouse, pen, or trackball, a voice input device, a scanning device, or another device that provides input to the computing system 10. For video encoding, the input device(s) 914 may be a camera, video card, TV tuner card, or similar device that accepts video input in analog or digital form, or a CD-ROM or CD-RW that reads video samples into the computing system 10. The output device(s) 912 may be a monitor, printer, speaker, CD-writer, or another device that provides output from the computing system 10.

The communication connection(s) 916 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

It should be understood that the functions/operations shown in this disclosure are provided for purposes of explanation of operations of certain embodiments. The implementation of the functions/operations performed by any particular module may be distributed across one or more systems and computer programs and are not necessarily contained within a particular computer program and/or computer system.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer implemented method for providing a digital agent that interacts with a user, the digital agent providing audio and visual outputs and accepting audio inputs, the method comprising:
accepting audio input from a user and processing the audio input substantially in real-time to generate a transcription of the audio input;
determining from a specified category, a context of the audio input;
performing with the context a contextual trade-off analysis of the transcription to generate an inferred intent of the audio input;
generating and providing to the user one or more outputs in the form of questions as a function of the inferred intent and receiving further inputs from the user to determine one or more modified contexts and one or more inferred intents; and
providing outputs to the user in the form of visual representations of at least a portion of a human being speaking audio output, the audio output synchronized with the visual representations of the human being, the outputs providing a substantially live interaction with the user.

2. The computer implemented method of claim 1 further comprising:
modifying the visual representations to adapt tone, personality and attitude of the visual representations in accordance with the context.

3. The computer implemented method of claim 1 wherein determining from a specified category, a context of the audio input comprises:
retrieving the category; and
generating a plurality of parameters that correspond to the category and that provide the context.

4. The computer implemented method of claim 1 wherein performing with the context a contextual trade-off analysis of the transcription to generate an inferred intent of the audio input comprises:
generating, from the context, with a rules based expert system, one or more prompts and providing the prompts to a large language model;
receiving responses from the large language model and identifying the inferred intent from the responses.

5. The computer implemented method of claim 4 wherein performing with the context a contextual trade-off analysis of the transcription to generate an inferred intent of the audio input comprises:
receiving one or more preferences provided by the user;
assigning a weight to each preference provided by the user in accordance with inputs received from the user; and
providing each preference and each associated weight to a recommendation engine.

6. The computer implemented method of claim 1 wherein generating and providing to the user one or more outputs in the form of questions as a function of the inferred intent comprises:
retrieving the questions from a questions library and supplementing the questions with additional text retrieved from a fillers library; and
modifying the questions retrieved from the questions library and the additional text retrieved from the fillers library in accordance with predetermined emotion, attitude, language and locale.

7. The computer implemented method of claim 1 wherein the digital agent provides audio and visual outputs and accepts audio inputs in connection with an application that permits the user to select a choice among a plurality of choices, the method further comprising:
(i) receiving further audio input from the user indicative of criteria for selection of a choice among a plurality of choices;
(ii) determining from the choice a modified context;
(iii) generating a question to the user to cause the user to provide an answer to the question;
(iv) generating, from the question, a translated question in accordance with predetermined emotion, attitude, language and locale;
(v) generating audio-visual output to provide the translated question to the user;
(vi) receiving a response from the user to the translated question;
(vii) determining if the response is within the modified context;
(viii) if the response is within the modified context, repeating operations (i) through (vii) a predetermined number of times;
(ix) generate from a final response of the user a result corresponding to the user's selection of a choice among a plurality of choices; and
(x) present to the user in audiovisual output the result.

8. The computer implemented method of claim 7 wherein the operation to generate from a final response of the user a result corresponding to the user's selection of a choice among a plurality of choices comprises:
performing tradeoff scoring with a weighted preference generator and a weighted preference data search engine;
wherein the weighted preference generator accepts inputs from user that comprise, selection of search criteria, adjustment of weights with respect to the search criteria, and an indication of subjective ordering of at least one of the search criteria;
wherein the weighted preference data searching includes determining weighted preference information including a plurality of the search criteria and a corresponding plurality of the weights signifying the relative importance of the search criteria, and querying an information source and ranking results of the querying based upon the weighted preference information.

9. The computer implemented method of claim 8 wherein determining weighted preference data comprises:
determining whether or not there should be further input from the user;
without further user input, providing at least one of default and automatically heuristically determined weights to the weighted preference data search engine;
if further user input is taken, determining whether the user should be allowed to select criteria;
if the user is not allowed to select criteria, providing at least one of default and automatically heuristically determined criteria selections for the user;
if the user is allowed to select criteria, accepting criteria from the user;
determining whether the user should be able to adjust weights and if not then providing at least one of default and automatically heuristically determined weights; and
if the user is allowed to select weights, accepting weights from the user.

10. The computer implemented method of claim 9 further comprising:
requesting subjective ordering by the user and if the user does not provide subjective ordering then generating an ordering.

11. A server computer system that provides a virtual agent which mimics human-to-human interactions with a user, the server computer system comprising:
data storage having stored therein,
a questions library comprising a plurality of questions to be provided to the user;
a fillers library comprising additional conversation to be provided to the user; and
a category that defines a category for interaction by the virtual agent;
one or more processors that execute instructions that cause the one or more processors to implement the virtual agent, the instructions comprising code that when executed by the one or more processors implements:
a listening and transcription module that generates transcribed audio input spoken by a user into text input;
an intent extraction module that receives the transcribed audio input and generates an inferred intent as a function of a context component generated by the listening and transcription module;
a context generation module that retrieves the category and generates a plurality of parameters that correspond to the category and that provide a context to user input;
a question generation module that generates, from the context, questions for the user from the questions library and that generates additional conversation with the user from the fillers library;
a translation module that identifies a language, locale, emotional tone and attitude for interaction with the user and that modifies questions and additional conversation generated by the question generation module in accordance with the language, locale, emotional tone and attitude;
a speaking module that generates audiovisual output to the user from text generated by the question generation module and modified by the translation module, the audiovisual output including a live visual representation of a person or avatar speaking the text generated by the question generation module and modified by the translation module; and
a flow control module that coordinates operation of the listening and transcription module, the intent extraction module, the context generation module, the question generation module, the translation module, and the speaking module.

12. The server computer system of claim 11 wherein the intent extraction module generates the inferred intent by generating prompts, in accordance with the context component, to one or more large language models.

13. The server computer system of claim 11 wherein the context generation module generates the plurality of parameters by retrieving the plurality of parameters from a set of stored parameters.

14. The server computer system of claim 11 wherein the intent extraction module generates the inferred intent by performing with the context component a contextual trade-off analysis of the transcribed audio.

15. The server computer system of claim 14 wherein the contextual trade-off analysis comprises:
generating, from the context component, with a rules based expert system, one or more prompts and providing the prompts to a large language model; and
receiving responses from the large language model and identifying the inferred intent from the responses.

16. The server computer system of claim 14 wherein the contextual trade-off analysis comprises:
receiving one or more preferences provided by the user;
assigning a weight to each preference provided by the user in accordance with inputs received from the user; and
providing each preference and each associated weight to a recommendation engine.

17. The server computer system of claim 11 wherein the virtual agent provides audio and visual outputs and accepts audio inputs in connection with an application that permits the user to select a choice among a plurality of choices, wherein the instructions further comprise code that when executed by the one or more processors causes the one or more processors to perform the operations of:
(i) receiving further audio input from the user indicative of criteria for selection of a choice among a plurality of choices;
(ii) determining from the choice a modified context;
(iii) generating a question to the user to cause the user to provide an answer to the question;
(iv) generating, from the question, a translated question in accordance with predetermined emotion, attitude, language and locale;
(v) generating audio-visual output to provide the translated question to the user;
(vi) receiving a response from the user to the translated question;
(vii) determining if the response is within the modified context;
(viii) if the response is within the modified context, repeating operations (i) through (vii) a predetermined number of times;
(ix) generate from a final response of the user a result corresponding to the user's selection of a choice among a plurality of choices; and
(x) present to the user in audiovisual output the result.

18. A non-transitory computer-readable storage medium with an executable computer program stored thereon for operating a computer system, the computer program comprising one or more code segments that when executed by the computer system implement:
a listening and transcription module that generates transcribed audio input spoken by a user into text input;
an intent extraction module that receives the transcribed audio input and generates an inferred intent as a function of a context component generated by the listening and transcription module;
a context generation module that retrieves the category and generates a plurality of parameters that correspond to the category and that provide a context to user input;
a question generation module that generates, from the context, questions for the user from the questions library and that generates additional conversation with the user from the fillers library;
a translation module that identifies a language, locale, emotional tone and attitude for interaction with the user and that modifies questions and additional conversation generated by the question generation module in accordance with the language, locale, emotional tone and attitude;
a speaking module that generates audiovisual output to the user from text generated by the question generation module and modified by the translation module, the audiovisual output including a live visual representation of a person or avatar speaking the text generated by the question generation module and modified by the translation module; and
a flow control module that coordinates operation of the listening and transcription module, the intent extraction module, the context generation module, the question generation module, the translation module, and the speaking module.

19. The non-transitory computer-readable storage medium of claim 18 wherein the intent extraction module generates the inferred intent by generating prompts, in accordance with the context component, to one or more large language models.

20. The non-transitory computer-readable storage medium of claim 18 wherein the context generation module generates the plurality of parameters by retrieving the plurality of parameters from a set of stored parameters.
